(19) United States
(12) Patent Application Publication
(10) Pub. No.: US 2025/0292453 A1
(43) Pub. Date: Sep. 18, 2025

(54) IMAGE PROCESSING METHOD, ELECTRONIC DEVICE, AND STORAGE MEDIUM

(71) Applicant: Beijing Zitiao Network Technology Co., Ltd., Beijing (CN)

(72) Inventors: Yi XU, Beijing (CN); Xinghua ZHANG, Beijing (CN); Yuening ZHANG, Beijing (CN); Danying LIU, Beijing (CN); Zhenyi KANG, Beijing (CN); Shuai LI, Beijing (CN)

(21) Appl. No.: 19/080,610

(22) Filed: Mar. 14, 2025

(30) Foreign Application Priority Data
Mar. 15, 2024 (CN) 202410303598.5

(51) Int. Cl. G06T 11/00; G06T 7/13; G06T 7/90; G06V 10/762; G06V 10/764; G06V 20/62

(52) U.S. Cl. CPC G06T 11/001; G06T 7/13; G06T 7/90; G06V 10/762; G06V 20/62; G06T 2207/10024; G06V 10/764

(57) ABSTRACT

Embodiments of the present disclosure provide an image processing method, an electronic device, and a storage medium. The method includes: obtaining an image to be processed and a target color card, where the image to be processed includes a target layer set, and the target layer set includes a material layer, where the material layer includes target materials of the image to be processed; grouping the target materials based on material attributes of the target materials, to obtain at least one material group; and determining a mapping relationship between the at least one material group and candidate colors in the target color card, obtaining a target color corresponding to each material group of the at least one material group based on the mapping relationship, and updating colors of target materials in each material group based on the target color.

### CROSS-REFERENCE TO RELATED APPLICATION

The present application claims the priority to Chinese Patent Application No. 202410303598.5, filed on Mar. 15, 2024, the entire disclosure of which is incorporated herein by reference as portion of the present application.

### TECHNICAL FIELD

Embodiments of the present disclosure relate to an image processing method and apparatus, an electronic device, and a storage medium.

### BACKGROUND

Currently, with the development of computer technologies, a user may use a computer device to design various types of images.

For example, in an image design interface, the user may manually select a color option of a target region in an image to be processed, and update a color of the target region in the image to be processed based on the selected color option. However, the above manner used to perform color matching adjustment on a multi-element and multi-layer image to be processed, such as a poster, may lead to problems of low processing efficiency and poor color matching effect.

### SUMMARY

The present disclosure provides an image processing method and apparatus, an electronic device, and a storage medium that can improve the image processing efficiency and enhance the color matching effect.

According to a first aspect, an embodiment of the present disclosure provides an image processing method. The method includes:
obtaining an image to be processed and a target color card, where the image to be processed includes a target layer set, and the target layer set includes a material layer, where the material layer includes target materials of the image to be processed;
grouping the target materials based on material attributes of the target materials, to obtain at least one material group; and
determining a mapping relationship between the at least one material group and candidate colors in the target color card, obtaining a target color corresponding to each material group based on the mapping relationship, and updating colors of target materials in a corresponding material group based on the target color.

According to a second aspect, an embodiment of the present disclosure further provides an image processing apparatus. The apparatus includes:
an image obtaining module, configured to obtain an image to be processed and a target color card, where the image to be processed includes a target layer set, and the target layer set includes a material layer, where the material layer includes target materials of the image to be processed;
a material grouping module, configured to group the target materials based on material attributes of the target materials to obtain at least one material group; and
a color update module, configured to determine a mapping relationship between the at least one material group and candidate colors in the target color card, obtain a target color corresponding to each material group based on the mapping relationship, and update colors of target materials in a corresponding material group based on the target color.

According to a third aspect, an embodiment of the present disclosure further provides an electronic device. The electronic device includes:
one or more processors; and
a storage apparatus configured to store one or more programs, where
the one or more programs, when executed by the one or more processors, cause the one or more processors to implement the image processing method according to any embodiment of the present disclosure.

According to a fourth aspect, an embodiment of the present disclosure further provides a storage medium including computer-executable instructions, where the computer-executable instructions, when executed by a computer processor, are used to perform the image processing method according to any embodiment of the present disclosure.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar. It should be understood that the accompanying drawings are schematic and that parts are not necessarily drawn to scale.

FIG. 1 is a schematic flowchart of an image processing method provided by an embodiment of the present disclosure;

FIG. 2 is a schematic diagram of a target color card provided by an embodiment of the present disclosure;

FIG. 3 is a schematic diagram of a hue transformation effect of target materials provided by an embodiment of the present disclosure;

FIG. 4 is a schematic diagram of a target image provided by an embodiment of the present disclosure;

FIG. 5 is a schematic diagram of a structure of an image processing apparatus provided by an embodiment of the present disclosure; and

FIG. 6 is a schematic diagram of a structure of an electronic device provided by an embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” used herein and the variations thereof are an open-ended inclusion, namely, “include but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

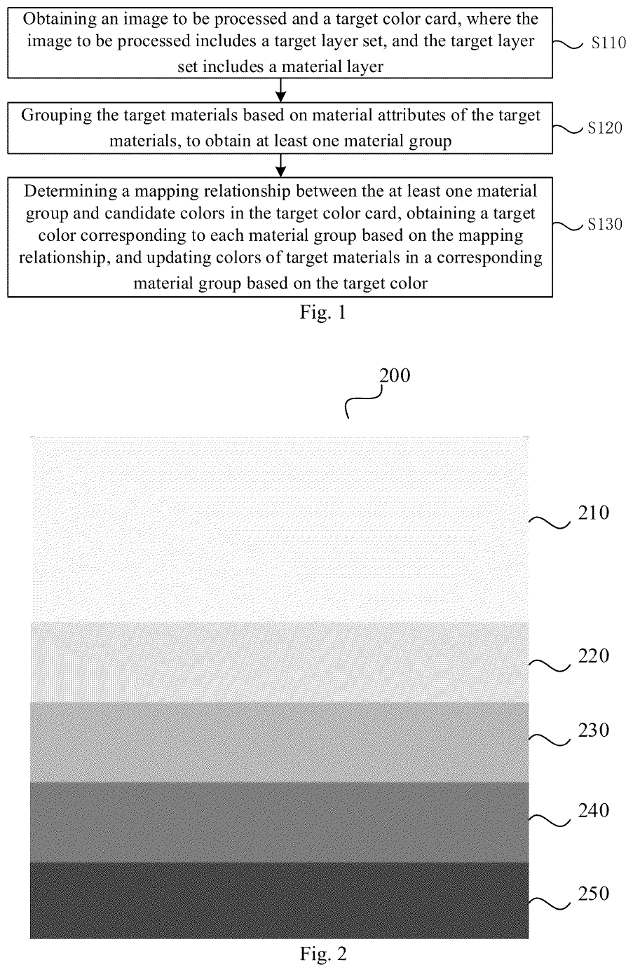

FIG. 1 is a schematic flowchart of an image processing method provided by an embodiment of the present disclosure, which is applicable to a case of adjusting the color matching of an image, for example, a scenario where color matching adjustment needs to be performed on an image when a product presentation image, a product poster or another image for publicity needs to be designed. The method may be performed by an image processing apparatus. The apparatus may be implemented in the form of software and/or hardware, and optionally, by an electronic device, which may be a mobile terminal, a PC terminal, a server, etc.

As shown in FIG. 1, the method includes the following steps.

S110: Obtaining an image to be processed and a target color card, where the image to be processed includes a target layer set, and the target layer set includes a material layer.

The material layer includes target materials of the image to be processed. The image to be processed may be generated by superimposing at least two layers with different graphic elements. For example, the image to be processed includes the target layer set, and the target layer set is a set of target layers. A color of the target material in the material layer includes one or more of hue, brightness, and saturation. The target layer includes a material layer, and the material layer includes the target materials of the image to be processed. For example, the material layer represents a target layer whose material content satisfies a preset material selection condition. The target material in the material layer may include at least one of materials such as a sticker, a shape and graffiti.

In this embodiment of the present disclosure, the target layer set further includes other types of target layers. For example, the target layers may further include an object layer, a background layer, a text layer, etc. The object layer includes a target object presented by the image to be processed. If the image to be processed is a product presentation image, the target object is a product. If the image to be processed is a magazine cover image, the target object is a magazine cover person, etc. Optionally, a graphic element that occupies the largest area in the image to be processed may be used as the target object. Alternatively, a foreground element of the image to be processed may also be used as the target object. Alternatively, a graphic element that represents an image subject in the image to be processed may also be used as the target object.

The target color card represents a selected candidate color card in a color matching adjustment page. The image to be processed and candidate color cards are presented in the color matching adjustment page, and a user may select the target color card from the candidate color cards based on an expected color matching effect of the image to be processed. The candidate color card includes sequentially arranged color blocks corresponding to a plurality of candidate colors. A color of the first color block in the candidate color card may be used as a dominant color, and a color of the last color block in the candidate color card may be used as an accent color. The color blocks between the first color block and the last color block are used as auxiliary color blocks, and colors of the auxiliary color blocks are used as auxiliary colors. For the candidate color card, a saturation difference between the color of the first auxiliary color block and the dominant color is less than a set threshold, and/or a brightness difference between the color of the first auxiliary color block and the dominant color is less than a set threshold, to ensure that the color of the first auxiliary color block is as close as possible to the dominant color in terms of saturation and/or brightness. The saturation and/or the brightness of the other auxiliary color blocks transition in turn. The saturation difference between the color of the last auxiliary color block and the accent color is less than a set threshold, and/or the brightness difference between the last auxiliary color block and the accent color is less than a set threshold, to ensure that the color of the last auxiliary color block is as close as possible to the accent color in terms of saturation and/or brightness. From the first color block to the last color block in the candidate color card, there is a rule that color block areas are decreased progressively.

FIG. 2 is a schematic diagram of a target color card provided by an embodiment of the present disclosure. As shown in FIG. 2, the target color card 200 includes a dominant color 210, a first auxiliary color 220, a second auxiliary color 230, a third auxiliary color 240, and an accent color 250. A color of the first auxiliary color 220 is similar to the dominant color 210 in terms of saturation and/or brightness. A color of the third auxiliary color 240 is similar to the accent color 250 in terms of saturation and/or brightness.

For example, a color matching adjustment page is presented, where the color matching adjustment page includes candidate image templates. In response to a selection event for the candidate image template, the selected target image template is presented. In response to an editing event for the target image template, the target object is obtained, and the target image template is updated by using the target object, to obtain the image to be processed. In response to a selection event for the candidate color card in the color matching adjustment page, the selected target color card is obtained.

In this embodiment of the present disclosure, since the object layer is used to present the target object of the image to be processed, color transformation is not performed on the object layer of the layer to be processed, to maintain an original color feature of the target object. The original color feature represents one or more color features of the target object, such as the hue, saturation, and brightness.

A background layer represents a background of the image to be processed. For example, a correspondence between the background layer and the dominant color is established, to change a color of the background layer to the dominant color.

The text layer includes text of the layer to be processed. A text color is composed of a word color, a shadow color, an outline color, and a background color.

For example, a target word color of the text in the text layer is determined based on the candidate colors in the target color card. A target shadow color, a target outline color and a target background color of the text are determined based on an original word color, the target word color, an original shadow color, an original outline color and an original background color of the text in the text layer. The text color of the text in the text layer is determined based on the target word color, the target shadow color, the target outline color, and the target background color of the text.

For example, the accent color in the target color card is used as the target word color of the text in the text layer, the target word color represents a color of the text and a shape, and color transformation is performed on the text and the shape in the text layer based on the accent color. Optionally, since image representation in an LCH color space is consistent with the habit of describing colors in daily life, and is easy to understand and more intuitive, the text in the text layer may be transformed into the LCH color space.

To avoid a sudden color change of the text after color transformation, it is necessary to maintain a difference between the target word color and the original word color equal to a difference between the target shadow color and the original shadow color, maintain the difference between the target word color and the original word color equal to a difference between the target outline color and the original outline color, and maintain the difference between the target word color and the original word color equal to a difference between the target background color and the original background color. The original word color, original shadow color, original outline color, and original background color of the text in the text layer are obtained through an image recognition technology. Since the target word color is the accent color in the target color card, the target shadow color is determined based on the condition that the difference between the target word color and the original word color is equal to the difference between the target shadow color and the original shadow color. The target outline color may also be determined based on the condition that the difference between the target word color and the original word color is equal to the difference between the target outline color and the original outline color. The target background color may also be determined based on the condition that the difference between the target word color and the original word color is equal to the difference between the target background color and the original background color. Then, the target word color, the target shadow color, the target outline color, and the target background color are combined to determine the text color of the text in the text layer.

S120: Grouping the target materials based on material attributes of the target materials, to obtain at least one material group.

The material attribute may represent a pixel attribute of the target material. For example, the material attribute may represent an image area determined based on a pixel region of the target material, etc.

For example, in response to material content corresponding to a target layer satisfying a preset material selection condition, the target layer is determined as the material layer. Image areas corresponding to the target materials in the material layer are obtained, and the target materials are grouped based on the image areas, to obtain the at least one material group.

The preset material selection condition may be determined based on a material type. In response to the material content in the target layer being at least one of materials such as a sticker, a shape, and graffiti, the target layer is used as the material layer. The image area may represent an area of the pixel region of the target material in the material layer.

Optionally, the grouping the target materials based on the image areas, to obtain at least one material group includes: determining a target area based on the image areas; determining area attributes of the target materials based on the image areas and the target area, and sorting the target materials based on the area attributes to obtain a material queue; and traversing the material queue, to obtain a current target material, and determining a material group to which the current material belongs based on an area attribute relationship between the current target material and an adjacent previous target material.

Optionally, the determining a material group to which the current material belongs based on an area attribute relationship between the current target material and an adjacent previous target material includes: in response to the area attribute relationship between the current target material and the adjacent previous target material satisfying a first grouping rule, determining that the current target material belongs to a material group corresponding to the previous target material; or in response to the area attribute relationship between the current target material and the adjacent previous target material satisfying a second grouping rule, determining a new material group based on the current target material.

The target area may represent an image area whose area value satisfies a preset selection condition. The area attribute may represent a quotient of the image area of the target material in the material layer relative to the target area. The area attribute relationship may represent a quotient of the area attributes of two adjacent target materials in the material queue. The target materials may be grouped based on a value interval and grouping rules. The first grouping rule represents that in response to the quotient of the area attributes between the adjacent target materials being less than a lower limit of a preset value interval, the adjacent target materials are classified into the same material group. The second grouping rule represents that in response to the quotient of the area attributes between the adjacent target materials being greater than or equal to the lower limit of the preset value interval, the adjacent target materials are classified into different material groups.

For example, in response to the material content of the target layer being at least one of materials such as a sticker, a shape, and graffiti, the target layer is used as the material layer. The image area of the target material is calculated based on the pixel region corresponding to the target material in the material layer. An area set S={s1, s2, s3, . . . , sN} is formed based on the areas of the target materials, where a set element si represents the image area of each target material, where i=1, 2, 3, . . . , N. The area corresponding to the smallest area value in the area set is determined as the target area.

A quotient of each set element in the area set and the target area is calculated as an area attribute of the target material corresponding to the set element. The target materials are sorted in ascending order according to the area attributes to get a material queue. A first material group is determined based on the first target material in the material queue. Then, the material queue is sequentially traversed, and in response to a second target material in the material queue being obtained, a quotient of the area attributes of the second target material and the first target material is calculated to serve as an area attribute relationship between the second target material and the first target material. In response to the quotient of the area attributes of the second target material and the first target material being less than a lower limit of a preset value interval, the second target material is classified into the material group corresponding to the first target material. In response to the quotient of the area attributes of the second target material and the first target material being greater than or equal to the lower limit of the preset value interval, a new material group is determined based on the second target material.

In response to a third target material in the material queue being obtained, a quotient of the area attributes of the third target material and the second target material is calculated as an area attribute relationship between the third target material and the second target material. In response to the quotient of the area attributes of the third target material and the second target material being less than a lower limit of a preset value interval, the third target material is classified into the material group corresponding to the second target material. In response to the quotient of the area attributes of the third target material and the second target material being greater than or equal to the lower limit of the preset value interval, a new material group is determined based on the third target material. The above operation is successively performed until the material queue is traversed, and the material groups to which the target materials in the material queue belong are obtained.

Optionally, since the target material is carried on the material layer, the material layers may also be grouped based on the image areas corresponding to the target materials in the material layers, to obtain at least one layer group. For example, the image area of the target materials in each material layer is calculated as an area corresponding to the material layer. The smallest area corresponding to a material layer is obtained as the target area. Then, the area corresponding to each material layer is divided by the target area to obtain a relative area multiple as the area attribute of each material layer. The material layers are sorted in ascending order based on the area attributes to get a layer queue. The layer queue is traversed to obtain a current material layer, and a layer group to which the current material layer belongs is determined based on an area attribute relationship between the current material layer and an adjacent previous material layer. For example, the area attribute of the current material layer is divided by the area attribute of the adjacent previous material layer to obtain an area attribute ratio. In response to the area attribute ratio being less than a lower limit of a preset number interval, the current material layer is classified into a layer group corresponding to the adjacent previous material layer, and otherwise, a new group is determined based on the current material layer. The material groups are then determined based on the target materials in the material layer in each layer group.

S130: Determining a mapping relationship between the at least one material group and candidate colors in the target color card, obtaining a target color corresponding to each material group based on the mapping relationship, and updating colors of target materials in a corresponding material group based on the target color.

The mapping relationship represents the correspondence between each material group in the at least one material group and each candidate color in the target color card. The target color card includes an auxiliary color sequence. The auxiliary color sequence includes auxiliary colors except the dominant color and the accent color in the candidate colors. The auxiliary colors are arranged in order of saturation and/or brightness. The first auxiliary color is as close as possible to the dominant color in terms of saturation and/or brightness, and the last auxiliary color is as close as possible to the accent color in terms of saturation and/or brightness.

In some embodiments, in response to a number of the at least one material group being greater than a number of candidate auxiliary colors in the auxiliary color sequence, the at least one material group is merged to obtain merged material groups, where a number of the merged material groups is equal to the number of the candidate auxiliary colors. An order of the merged material groups is determined based on the image areas of the target materials in the merged material groups. A mapping relationship between the merged material groups and the candidate auxiliary colors in the auxiliary color sequence is determined based on an order of the merged material groups and an order of the candidate auxiliary colors in the auxiliary color sequence.

Assuming that the target materials are grouped into K material groups, and the number of the candidate auxiliary colors in the auxiliary color sequence is 3. When K>3, the K material groups are merged into three merged material groups. The specific manner may include: the K material groups are sorted based on the sum of the areas of the target materials in the groups, or the K material groups are sorted based on a material group generation order. The embodiments of the present disclosure do not specifically limit a sorting manner of the K material groups. When K is an even number, the material group corresponding to K/2 is used as one merged material group, the material groups located before the material group corresponding to K/2 among the K material groups are merged into one merged material group, and the material groups located after the material group corresponding to K/2 among the K material groups are merged into one merged material group. When K is an odd number, the material groups located at the middle position among the K groups is used as one merged material group, the material groups located before the middle position are merged into one merged material group, and the material groups located after the middle position are merged into one merged material group.

The order of the merged material groups is determined based on the image areas of the target materials in the merged material groups. Alternatively, the order of the merged material groups may be determined based on a merging manner of the merged material groups. For example, the material group corresponding to K/2 is located at a middle position, the material groups before the material group corresponding to K/2 are located before the middle position, and the material groups after the material group corresponding to K/2 are located after the middle position. Therefore, the order of the merged material groups may be determined based on the merging manner.

The mapping relationship between the merged material group before the middle position and the auxiliary color (referring to the third auxiliary color 240 in FIG. 2) adjacent to the accent color is established. The mapping relationship between the merged material group after the middle position and the auxiliary color (referring to the first auxiliary color 220 in FIG. 2) adjacent to the dominant color is established. The mapping relationship between the merged material group at the middle position and the remaining auxiliary color (referring to the second auxiliary color 230 in FIG. 2) is established.

In other embodiments, in response to a number of the at least one material group being less than or equal to a number of candidate auxiliary colors in the auxiliary color sequence, an order of the material groups is determined based on image areas of target materials in the material groups. A mapping relationship between the material groups and the candidate auxiliary colors in the auxiliary color sequence is determined based on an order of the material groups and an order of the candidate auxiliary colors in the auxiliary color sequence.

Assuming that the target materials are grouped into K material groups and the number of the candidate auxiliary colors in the auxiliary color sequence is 3. When K=3, the mapping relationship between the material group having the smallest area and the third auxiliary color is established, and the mapping relationship between the material group having the largest area and the first auxiliary color is established, and the mapping relationship between the remaining material group and the second auxiliary color is established.

When K=2, the mapping relationship between the material group having a larger area and the first auxiliary color is established, and the mapping relationship between the material group having a smaller area and the second auxiliary color is established.

When K=1, the mapping relationship between the material group and the first auxiliary color is established.

For example, a target color corresponding to each material group is obtained based on the mapping relationship. An original color of the target material in the material group is obtained, and an original hue is determined based on the original color. A target hue is determined based on the target color, and a hue rotation matrix is determined based on the target hue and the original hue. The pixel values of the target materials in the material group are updated based on the hue rotation matrix. The original color represents a primary color of the target material in the image to be processed. The pixel value with the largest number of pixels in the target material may be determined as the primary color. The original hue represents a hue value of the primary color of the target material in the image to be processed.

The target color represents the candidate auxiliary color corresponding to each material group in the target color card, and the target color corresponding to each material group may be obtained based on the above mapping relationship. The original color may represent the pixel values of the target materials in the image to be processed. The original hue of the target material may be determined based on the pixel values of the target materials in the image to be processed. The hue rotation matrix represents a color matrix based on a rotation angle, and hue transformation may be performed on the target materials in each material group through the hue rotation matrix. The hue rotation matrix is determined based on a hue difference between the original hue and the target hue of the target material.

For one target material in the material group, the original color of the target material is obtained, the original hue is determined based on the original color. The target hue is determined based on the target color, and the hue difference between the target hue and the original hue is calculated. A hue angle matrix is determined based on a predefined target constant and the hue difference. An angle array corresponding to the hue angle matrix is transformed into a radian set, and sine values and cosine values corresponding to radians in the radian set are calculated respectively. Then, the hue rotation matrix is determined based on the sine values and the cosine values corresponding to the radians and the target constant. Then, a product of the original color of each pixel in the target material under an RGB color space and the hue rotation matrix is calculated to obtain the target material with an updated color.

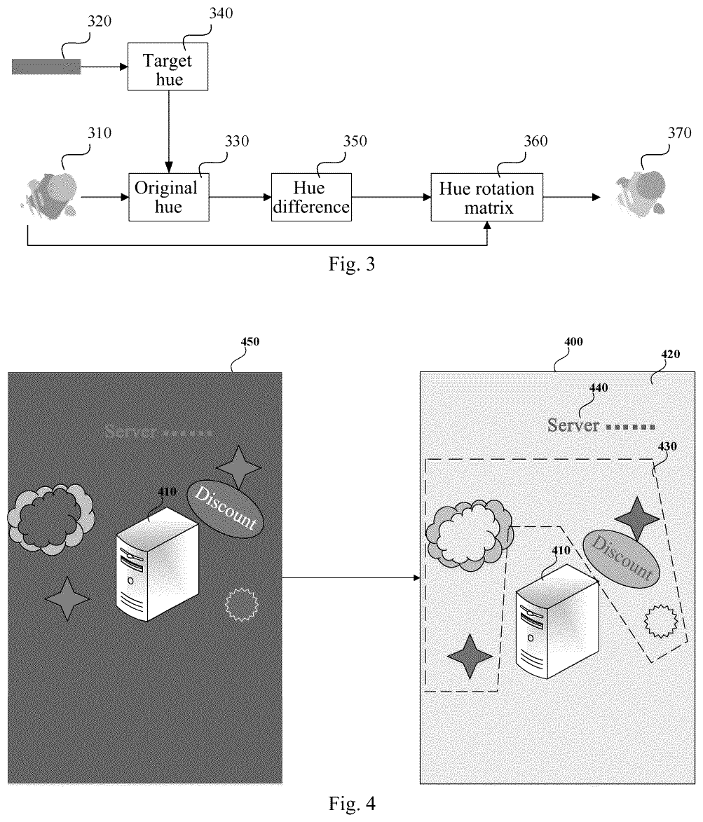

FIG. 3 is a schematic diagram of a hue transformation effect of target materials provided by an embodiment of the present disclosure. As shown in FIG. 3, a primary color hue in a target material 310 in a material group of an original image is extracted as an original hue 330. A hue of a target color 320 corresponding to the material group is extracted as a target hue 340. A hue rotation matrix 360 is determined based on a hue difference 350 between the target hue 340 and the original hue 330, and then an RGB value of each pixel in the target material 310 is multiplied by the hue rotation matrix 360, to obtain a result image 370 after hue transformation.

Optionally, a determining process of the hue rotation matrix of each above material group and a color update process of the target material may be encapsulated by using a shader, and then, codes encapsulated by the shader are executed in parallel by a GPU, and hue transformation on the plurality of target materials in the same material group is performed in parallel, or hue transformation on the target materials in different material groups is performed in parallel, which improves the hue transformation efficiency of the material layer, and reduces the time needed for hue transformation.

FIG. 4 is a schematic diagram of a target image provided by an embodiment of the present disclosure. The target image is an image that satisfies a color matching expectation after color matching adjustment is performed on the image to be processed. For example, color matching adjustment is first performed on the target layer of the image to be processed, and then the object layer, the background layer, the material layer and the text layer are fused to get the target image satisfying the color matching expectation. As shown in FIG. 4, the target image 400 and the image to be processed 450 have different colors on a background layer 420, a material layer 430, and a text layer 440, respectively. An object layer 410 of the target image 400 maintains an original color feature of the target object in the image to be processed 450. The color of the background layer 420 is the dominant color in the target color card. The color of the target material in the material layer 430 is the auxiliary color corresponding to the material group to which the target material belongs. The word color of the text in the text layer 440 is the accent color in the target color card.

According to the technical solution of this embodiment of the present disclosure, by grouping the target materials in the image to be processed, determining the mapping relationship between the material groups and the candidate colors in the target color card, and then determining the target color corresponding to each material group based on the mapping relationship and updating the colors of the target materials in the corresponding material group based on the target color, graphic elements such as patterns, text and textures in the image to be processed can be retained, and the colors of the target materials can be automatically updated based on the selected target color card, which rectifies the defects of low processing efficiency and poor color matching effect in a related color matching solution, and can improve the image processing efficiency and enhance the color matching effect.

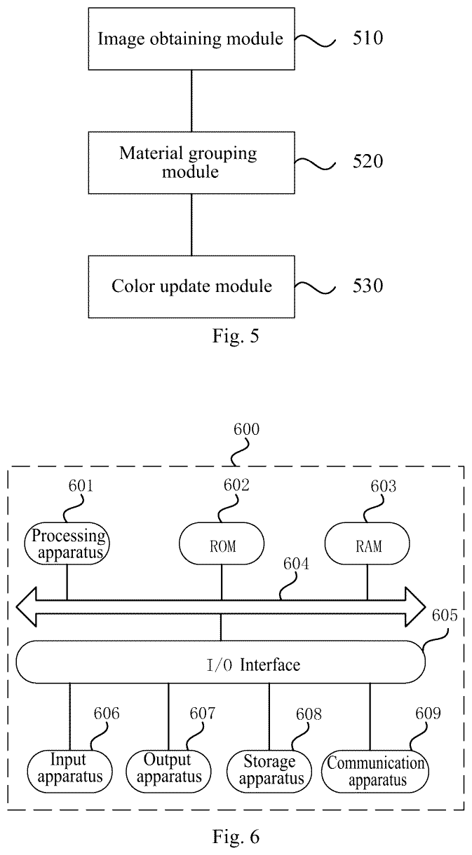

FIG. 5 is a schematic diagram of a structure of an image processing apparatus provided by an embodiment of the present disclosure, which may be implemented in the form of software and/or hardware, and optionally, by an electronic device, which may be a mobile terminal, a PC terminal, a server, etc.

As shown in FIG. 5, the apparatus includes: an image obtaining module 510, a material grouping module 520, and a color update module 530.

The image obtaining module 510 is configured to obtain an image to be processed and a target color card, where the image to be processed includes a target layer set, and the target layer set includes a material layer, where the material layer includes target materials of the image to be processed.

The material grouping module 520 is configured to group the target materials based on material attributes of the target materials, to obtain at least one material group.

The color update module 530 is configured to determine a mapping relationship between the at least one material group and candidate colors in the target color card, obtain a target color corresponding to each material group based on the mapping relationship, and update colors of target materials in a corresponding material group based on the target color.

Optionally, the material grouping module 520 is specifically configured to:
in response to material content corresponding to a target layer satisfying a preset material selection condition, determine the target layer as the material layer; and
obtain image areas corresponding to the target materials in the material layer, and group the target materials based on the image areas, to obtain the at least one material group.

Further, the grouping the target materials based on the image areas, to obtain the at least one material group includes:
determining a target area based on the image areas;
determining area attributes of the target materials based on the image areas and the target area, and sorting the target materials based on the area attributes to obtain a material queue; and
traversing the material queue, to obtain a current target material, and determining a material group to which the current material belongs based on an area attribute relationship between the current target material and an adjacent previous target material.

Further, the determining a material group to which the current material belongs based on an area attribute relationship between the current target material and an adjacent previous target material includes:
in response to the area attribute relationship between the current target material and the adjacent previous target material satisfying a first grouping rule, determining that the current target material belongs to a material group corresponding to the previous target material; or
in response to the area attribute relationship between the current target material and the adjacent previous target material satisfying a second grouping rule, determining a new material group based on the current target material.

Optionally, the color update module 530 is specifically configured to:
obtain an original color of the target material in the material group, and determine an original hue based on the original color;
determine a target hue based on the target color, and determine a hue rotation matrix based on the target hue and the original hue; and
update pixel values of the target material in the material group based on the hue rotation matrix.

Optionally, the target color card includes an auxiliary color sequence. The color update module 530 is further specifically configured to:
in response to a number of the at least one material group being greater than a number of candidate auxiliary colors in the auxiliary color sequence, merge the at least one material group, to obtain merged material groups, where a number of the merged material groups is equal to the number of the candidate auxiliary colors; and
determine a mapping relationship between the merged material groups and the candidate auxiliary colors in the auxiliary color sequence based on an order of the merged material groups and an order of the candidate auxiliary colors in the auxiliary color sequence.

Optionally, the target color card includes an auxiliary color sequence. The color update module 530 is further specifically configured to:
in response to a number of the at least one material group being less than or equal to a number of candidate auxiliary colors in the auxiliary color sequence, determine an order of the material groups based on image areas of target materials in the material groups; and
determine a mapping relationship between the material group and the candidate auxiliary color in the auxiliary color sequence based on an order of the material groups and an order of the candidate auxiliary colors in the auxiliary color sequence.

Optionally, the target layer set further includes a text layer. The apparatus further includes a text color determining module configured to:
determine a target word color of text in the text layer based on the candidate colors in the target color card, after an image to be processed and a target color card are obtained;
determine a target shadow color, a target outline color and a target background color of the text based on an original word color, the target word color, an original shadow color, an original outline color and an original background color of the text in the text layer; and
determine a text color of the text in the text layer based on the target word color, the target shadow color, the target outline color, and the target background color of the text.

The image processing apparatus provided in this embodiment of the present disclosure can perform the image processing method provided in any embodiment of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the protection scope of the embodiments of the present disclosure.

FIG. 6 is a schematic diagram of a structure of an electronic device provided by an embodiment of the present disclosure. Reference is made to FIG. 6 below, which is a schematic diagram of a structure of an electronic device (such as a terminal device or a server in FIG. 6) 600 suitable for implementing embodiments of the present disclosure. The terminal device in this embodiment of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 600 may include a processing apparatus (e.g., a central processing unit or a graphics processing unit) 601 that may perform a variety of appropriate actions and processing in accordance with a program stored in a read-only memory (ROM) 602 or a program loaded from a storage apparatus 608 into a random access memory (RAM) 603. The RAM 603 further stores various programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, and a gyroscope; an output apparatus 607 including, for example, a liquid crystal display (LCD), a speaker, and a vibrator; the storage apparatus 608 including, for example, a tape and a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 609 and installed, installed from the storage apparatus 608, or installed from the ROM 602. When the computer program is executed by the processing apparatus 601, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device according to this embodiment of the present disclosure and the image processing methods according to the above embodiments belong to the same inventive concept. For the technical details not exhaustively described in this embodiment, reference may be made to the above embodiments, and this embodiment and the above embodiments have the same beneficial effects.

An embodiment of the present disclosure provides a computer storage medium having stored thereon a computer program that, when executed by a processor, causes the image processing method provided in the above embodiments to be implemented.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to:
obtain an image to be processed and a target color card, where the image to be processed includes a target layer set, and the target layer set includes a material layer, where the material layer includes target materials of the image to be processed;
group the target materials based on material attributes of the target materials, to obtain at least one material group; and
determine a mapping relationship between the at least one material group and candidate colors in the target color card, obtain a target color corresponding to each material group based on the mapping relationship, and update colors of target materials in a corresponding material group based on the target color.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of a unit does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. An image processing method, comprising:
obtaining an image to be processed and a target color card, wherein the image to be processed comprises a target layer set, and the target layer set comprises a material layer, wherein the material layer comprises target materials of the image to be processed;
grouping the target materials based on material attributes of the target materials, to obtain at least one material group; and
determining a mapping relationship between the at least one material group and candidate colors in the target color card, obtaining a target color corresponding to each material group of the at least one material group based on the mapping relationship, and updating colors of the target materials in each material group based on the target color.

2. The method according to claim 1, wherein the grouping the target materials based on the material attributes of the target materials, to obtain the at least one material group comprises:
in response to material content corresponding to a target layer satisfying a preset material selection condition, determining the target layer as the material layer; and
obtaining image areas corresponding to the target materials in the material layer, and grouping the target materials based on the image areas, to obtain the at least one material group.

3. The method according to claim 2, wherein the grouping the target materials based on the image areas, to obtain the at least one material group comprises:
determining a target area based on the image areas;
determining area attributes of the target materials based on the image areas and the target area, and sorting the target materials based on the area attributes, to obtain a material queue; and
traversing the material queue, to obtain a current target material, and determining a material group to which the current material belongs based on an area attribute relationship between the current target material and an adjacent previous target material.

4. The method according to claim 3, wherein the determining the material group to which the current material belongs based on the area attribute relationship between the current target material and the adjacent previous target material comprises:
in response to the area attribute relationship between the current target material and the adjacent previous target material satisfying a first grouping rule, determining that the current target material belongs to a material group corresponding to the previous target material; or
in response to the area attribute relationship between the current target material and the adjacent previous target material satisfying a second grouping rule, determining a new material group based on the current target material.

5. The method according to claim 1, wherein the updating the colors of the target materials in each material group based on the target color comprises:
obtaining an original color of the target material in the material group, and determining an original hue based on the original color;
determining a target hue based on the target color, and determining a hue rotation matrix based on the target hue and the original hue; and
updating pixel values of the target materials in each material group based on the hue rotation matrix.

6. The method according to claim 1, wherein the target color card comprises an auxiliary color sequence; and the determining the mapping relationship between the at least one material group and the candidate colors in the target color card comprises:
in response to a number of the at least one material group being greater than a number of candidate auxiliary colors in the auxiliary color sequence, merging the at least one material group, to obtain merged material groups, wherein a number of the merged material groups is equal to the number of the candidate auxiliary colors; and
determining a mapping relationship between the merged material groups and the candidate auxiliary colors in the auxiliary color sequence based on an order of the merged material groups and an order of the candidate auxiliary colors in the auxiliary color sequence.

7. The method according to claim 1, wherein the target color card comprises an auxiliary color sequence; and the determining the mapping relationship between the at least one material group and the candidate colors in the target color card comprises:
in response to a number of the at least one material group being less than or equal to a number of candidate auxiliary colors in the auxiliary color sequence, determining an order of the at least one material group based on image areas of the target materials in each material group; and
determining a mapping relationship between each material group and the candidate auxiliary colors in the auxiliary color sequence based on the order of the at least one material group and an order of the candidate auxiliary colors in the auxiliary color sequence.

8. The method according to claim 1, wherein the target layer set further comprises a text layer, and after the obtaining the image to be processed and the target color card, the method further comprises:
determining a target word color of text in the text layer based on the candidate colors in the target color card;
determining a target shadow color, a target outline color and a target background color of the text based on an original word color, the target word color, an original shadow color, an original outline color and an original background color of the text in the text layer; and
determining a text color of the text in the text layer based on the target word color, the target shadow color, the target outline color, and the target background color of the text.

9. An electronic device, comprising:
one or more processors; and
a storage apparatus, configured to store one or more programs, wherein
the one or more programs, when executed by the one or more processors, cause the one or more processors to implement an image processing method, which comprises:
obtaining an image to be processed and a target color card, wherein the image to be processed comprises a target layer set, and the target layer set comprises a material layer, wherein the material layer comprises target materials of the image to be processed;
grouping the target materials based on material attributes of the target materials, to obtain at least one material group; and
determining a mapping relationship between the at least one material group and candidate colors in the target color card, obtaining a target color corresponding to each material group of the at least one material group based on the mapping relationship, and updating colors of the target materials in each material group based on the target color.

10. The electronic device according to claim 9, wherein the grouping the target materials based on the material attributes of the target materials, to obtain the at least one material group comprises:
in response to material content corresponding to a target layer satisfying a preset material selection condition, determining the target layer as the material layer; and
obtaining image areas corresponding to the target materials in the material layer, and grouping the target materials based on the image areas, to obtain the at least one material group.

11. The electronic device according to claim 10, wherein the grouping the target materials based on the image areas, to obtain the at least one material group comprises:
determining a target area based on the image areas;
determining area attributes of the target materials based on the image areas and the target area, and sorting the target materials based on the area attributes, to obtain a material queue; and
traversing the material queue, to obtain a current target material, and determining a material group to which the current material belongs based on an area attribute relationship between the current target material and an adjacent previous target material.

12. The electronic device according to claim 11, wherein the determining the material group to which the current material belongs based on the area attribute relationship between the current target material and the adjacent previous target material comprises:
in response to the area attribute relationship between the current target material and the adjacent previous target material satisfying a first grouping rule, determining that the current target material belongs to a material group corresponding to the previous target material; or
in response to the area attribute relationship between the current target material and the adjacent previous target material satisfying a second grouping rule, determining a new material group based on the current target material.

13. The electronic device according to claim 9, wherein the updating the colors of the target materials in each material group based on the target color comprises:
obtaining an original color of the target material in the material group, and determining an original hue based on the original color;
determining a target hue based on the target color, and determining a hue rotation matrix based on the target hue and the original hue; and
updating pixel values of the target materials in each material group based on the hue rotation matrix.

14. The electronic device according to claim 9, wherein the target color card comprises an auxiliary color sequence; and the determining the mapping relationship between the at least one material group and the candidate colors in the target color card comprises:
in response to a number of the at least one material group being greater than a number of candidate auxiliary colors in the auxiliary color sequence, merging the at least one material group, to obtain merged material groups, wherein a number of the merged material groups is equal to the number of the candidate auxiliary colors; and
determining a mapping relationship between the merged material groups and the candidate auxiliary colors in the auxiliary color sequence based on an order of the merged material groups and an order of the candidate auxiliary colors in the auxiliary color sequence.

15. The electronic device according to claim 9, wherein the target color card comprises an auxiliary color sequence; and the determining the mapping relationship between the at least one material group and the candidate colors in the target color card comprises:
in response to a number of the at least one material group being less than or equal to a number of candidate auxiliary colors in the auxiliary color sequence, determining an order of the at least one material group based on image areas of target materials in each material group; and
determining a mapping relationship between each material group and the candidate auxiliary colors in the auxiliary color sequence based on the order of the at least one material group and an order of the candidate auxiliary colors in the auxiliary color sequence.

16. The electronic device according to claim 9, wherein the target layer set further comprises a text layer, and after the obtaining the image to be processed and the target color card, the method further comprises:
determining a target word color of text in the text layer based on the candidate colors in the target color card;
determining a target shadow color, a target outline color and a target background color of the text based on an original word color, the target word color, an original shadow color, an original outline color and an original background color of the text in the text layer; and
determining a text color of the text in the text layer based on the target word color, the target shadow color, the target outline color, and the target background color of the text.

17. A non-transitory storage medium containing computer-executable instructions, wherein the computer-executable instructions, when executed by a computer processor, perform an image processing method, which comprises:
obtaining an image to be processed and a target color card, wherein the image to be processed comprises a target layer set, and the target layer set comprises a material layer, wherein the material layer comprises target materials of the image to be processed;
grouping the target materials based on material attributes of the target materials, to obtain at least one material group; and
determining a mapping relationship between the at least one material group and candidate colors in the target color card, obtaining a target color corresponding to each material group of the at least one material group based on the mapping relationship, and updating colors of the target materials in each material group based on the target color.

18. The medium according to claim 17, wherein the grouping the target materials based on the material attributes of the target materials, to obtain the at least one material group comprises:
in response to material content corresponding to a target layer satisfying a preset material selection condition, determining the target layer as the material layer; and
obtaining image areas corresponding to the target materials in the material layer, and grouping the target materials based on the image areas, to obtain the at least one material group.

19. The medium according to claim 18, wherein the grouping the target materials based on the image areas, to obtain the at least one material group comprises:
determining a target area based on the image areas;
determining area attributes of the target materials based on the image areas and the target area, and sorting the target materials based on the area attributes, to obtain a material queue; and
traversing the material queue, to obtain a current target material, and determining a material group to which the current material belongs based on an area attribute relationship between the current target material and an adjacent previous target material.

20. The medium according to claim 19, wherein the determining the material group to which the current material belongs based on the area attribute relationship between the current target material and the adjacent previous target material comprises:
in response to the area attribute relationship between the current target material and the adjacent previous target material satisfying a first grouping rule, determining that the current target material belongs to a material group corresponding to the previous target material; or
in response to the area attribute relationship between the current target material and the adjacent previous target material satisfying a second grouping rule, determining a new material group based on the current target material.
